(19) United States
(12) Patent Application Publication
(10) Pub. No.: US 2025/0303898 A1
(43) Pub. Date: Oct. 2, 2025

(54) ENVIRONMENTAL PROTECTION FOR EV CHARGING SYSTEM

(71) Applicant: NexE, LLC, Round Rock, TX (US)

(72) Inventors: Enrique Ledezma, Austin, TX (US); Dean Sarandria, Jonestown, TX (US); Sean Gresham, Georgetown, TX (US); Richard Trent, Jonestown, TX (US); Liangyu Chen, Georgetown, TX (US)

(21) Appl. No.: 18/619,824

(22) Filed: Mar. 28, 2024

(51) Int. Cl. B60L 53/31; B60L 53/67; H02J 7/00

(52) U.S. Cl. CPC B60L 53/31; B60L 53/67; H02J 7/0031

(57) ABSTRACT

In one embodiment, an apparatus includes: a frame to support a plurality of electric vehicle (EV) chargers; the EV chargers, each including or coupled to a dispenser to provide charging power to at least one EV; and at least one actuator coupled to at least a portion of the frame. In response to a flooding condition in a vicinity of the apparatus, the at least one actuator can raise the EV chargers to a raised position.

### BACKGROUND

When an electric vehicle (EV) charging system is commissioned on low terrain areas such as commercial parking lots exposed to the elements, including potential inundation conditions ranging from a few inches to feet of water, the equipment is subject to damage. This exposure may leave electrical equipment of the EV charging system vulnerable to water inundation and subsequent total equipment lost. Typically, an EV charging system is anchored to ground level or on an inadequate pedestal to prevent equipment flooding.

In addition, other locations with nearby periodic flood conditions such as ocean storm surges, near riverbank areas, lakes, lagoons, or swamped areas, and other low ground commissioning sites are currently unsuitable for EV charging installations.

### SUMMARY OF THE INVENTION

In one aspect, an apparatus includes: a frame to support a plurality of electric vehicle (EV) chargers; the plurality of EV chargers, each of the plurality of EV chargers comprising a dispenser to provide charging power to at least one EV; and at least one actuator coupled to at least a portion of the frame, wherein in response to a flooding condition in a vicinity of the apparatus, the at least one actuator is to raise the plurality of EV chargers to a raised position.

In an embodiment, the apparatus further comprises at least one buoyant member adapted to at least a portion of the frame, wherein in the flooding condition in the vicinity of the apparatus, the at least one buoyant member is to cause the plurality of EV chargers to float above the flooding condition. The at least one buoyant member comprises a plurality of floating members, and each of the plurality of EV chargers is adapted above at least one of the plurality of floating members. Each of the plurality of floating members may be implemented as a buoyant foam or plastic enclosure.

In an embodiment, the apparatus further comprises at least one environmental sensor to identify the flooding condition. The at least one environmental sensor comprises at least one sensor to sense that at least one of the plurality of EV chargers has changed position. The apparatus may include a first circuit breaker coupled to the plurality of EV chargers, where the first circuit breaker is to prevent power from being provided to the plurality of EV chargers. The apparatus may include a controller coupled to the first circuit breaker, where in response to an indication of the flooding condition, the controller is to cause the first circuit breaker to remove power to the plurality of EV chargers. The controller, in response to the indication of the flooding condition, is to cause the at least one actuator to raise the plurality of EV chargers to the raised position. The controller, in response to an indication that the flooding condition has resolved, is to cause the at least one actuator to return the plurality of EV chargers to a lowered position and enable the first circuit breaker to provide the power to the plurality of EV chargers.

In an embodiment, the apparatus further comprises at least one second circuit breaker, wherein the controller is to cause the at least one second circuit breaker to remove power to a first EV charger of the plurality of EV chargers in response to an indication of a failure in the first EV charger. The frame may include a plurality of vertical members, where each of the plurality of EV chargers is adapted about a corresponding one of the plurality of vertical members to enable the corresponding EV charger to move vertically about the corresponding vertical member. The frame may include a plurality of platforms, each of the plurality of EV chargers adapted on one of the plurality of platforms. The frame may be affixed to a ground level on a mechanical extension or a pedestal to avoid an inundation condition.

In another aspect, a method includes: detecting, in a controller of an environmentally protected EV charging system comprising a plurality of EV chargers, an environmental triggering condition; in response to detecting the environmental triggering condition, causing the plurality of EV chargers to be de-activated and disconnected from an input power source; and moving the plurality of EV chargers to avoid the environmental triggering condition. Moving the plurality of EV chargers to avoid the environmental triggering condition may include floating the plurality of EV chargers above a nominal position.

In an embodiment, the method further comprises: receiving, in the controller, a sensor input to detect the environmental triggering condition; and in response to the sensor input, sending a control signal to one or more actuators to cause the one or more actuators to raise the plurality of EV chargers above a nominal position to avoid the environmental triggering condition. The method may further comprise: detecting, in the controller, a resolution of the environmental triggering condition; and in response to detecting the resolution of environmental triggering condition, causing the input power source to be re-connected to the plurality of EV chargers. The method may also include causing the input power source to be re-connected to the plurality of EV chargers via a remote control operation.

In yet another aspect, a system includes: a dock to support a plurality of EV chargers, the dock to float on a water surface; the plurality of EV chargers, each of the plurality of EV chargers comprising a dispenser to provide charging power to at least one EV; an anchoring system to support the dock, the anchoring system comprising a plurality of anchors extending from a bottom of the dock to a floor below the water surface; and a pile guide system having a plurality of pile guides, wherein during an environmental condition, the dock is to float upwardly or downwardly about the plurality of pile guides.

In an embodiment, the system further comprises a distribution power circuit adapted on the dock to provide power to the plurality of EV chargers. The system may further include a power source located adjacent the water surface on dry land, the power source to receive power from a utility grid and provide the power to the distribution power circuit. The system may further comprise a submarine cable to couple the power source to the distribution power circuit, at least a portion of the submarine cable submerged below the water surface.

### BRIEF DESCRIPTION OF THE DRAWINGS

FIGS. 1A-1D are schematic diagrams of apparatus in accordance with embodiments.

FIG. 2 is a closeup view of an EV charger in a raised position in accordance with an embodiment.

FIG. 3 is a side view of an apparatus in accordance with an embodiment.

FIG. 4 is an illustration of a power supply arrangement in accordance with an embodiment.

FIG. 5 is a flow diagram of a method in accordance with an embodiment.

FIG. 6 is a block diagram of a system in accordance with another embodiment.

### DETAILED DESCRIPTION

In various embodiments, an EV charging system can be provided with environmental protection. For purposes of introduction, the environmental protection may be provided to dynamically move components of an EV charging module (e.g., converter and dispenser) away from a flooding or other environmental trigger condition. To this end, embodiments provide mechanisms and associated control aspects that enable the EV charging system (or at least portions thereof) to float over a rising water surface, e.g., by using a guided vertical mechanism as described herein.

As will be described further below, a system may include multiple EV DC charging modules that are adapted to a frame, such as may be implemented as a skid system. The individual or a group of EV DC charging modules can be configured to be dynamically controlled to move or to be displaced by buoyancy to a safe physical height when an environmental trigger condition occurs and/or is detected, e.g., via one or more sensors. This action prevents equipment of the EV DC charging modules from being exposed to running water and to potential total damage.

Embodiments may include a mechanical safety device and/or mechanical circuit breaker triggered by one or more sensors to turn system power off as potential flood conditions are detected. The overall EV charging system and its mechanical frame or skid structure may be configured to withstand water surge forces expected under described environmental conditions.

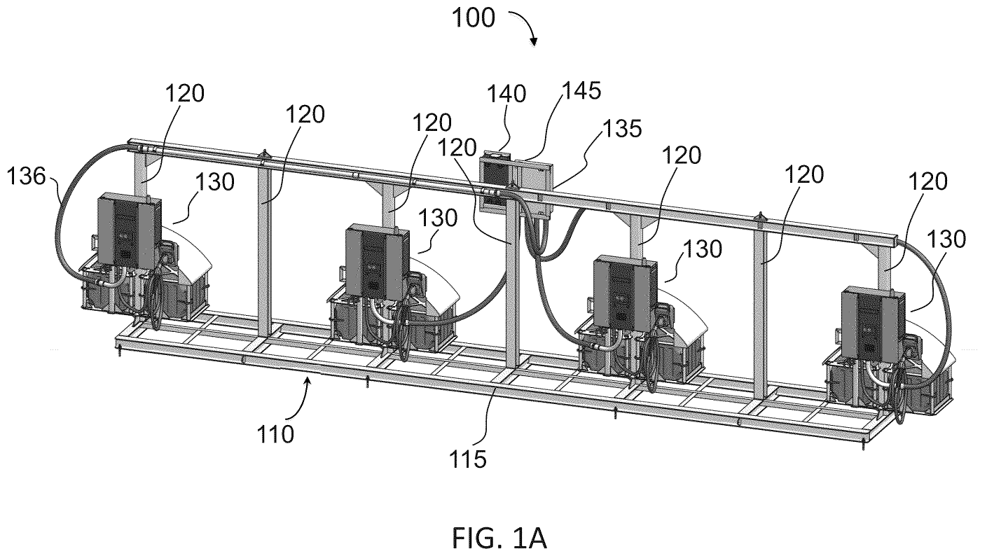

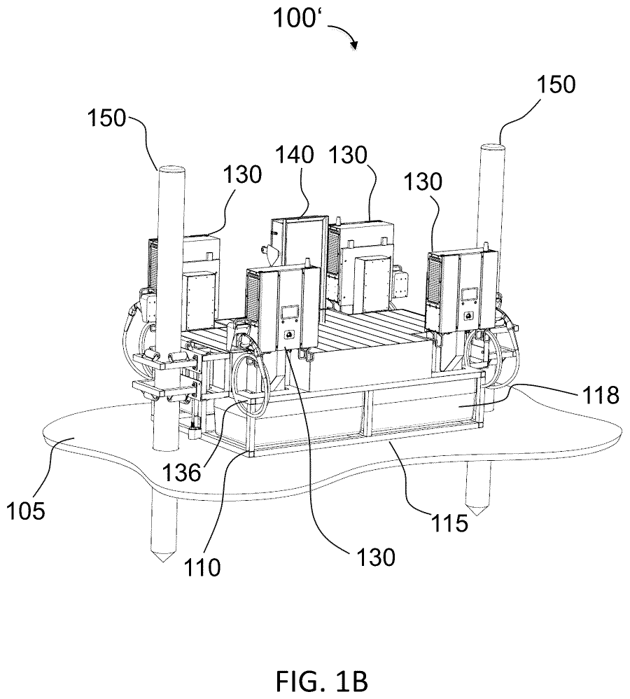

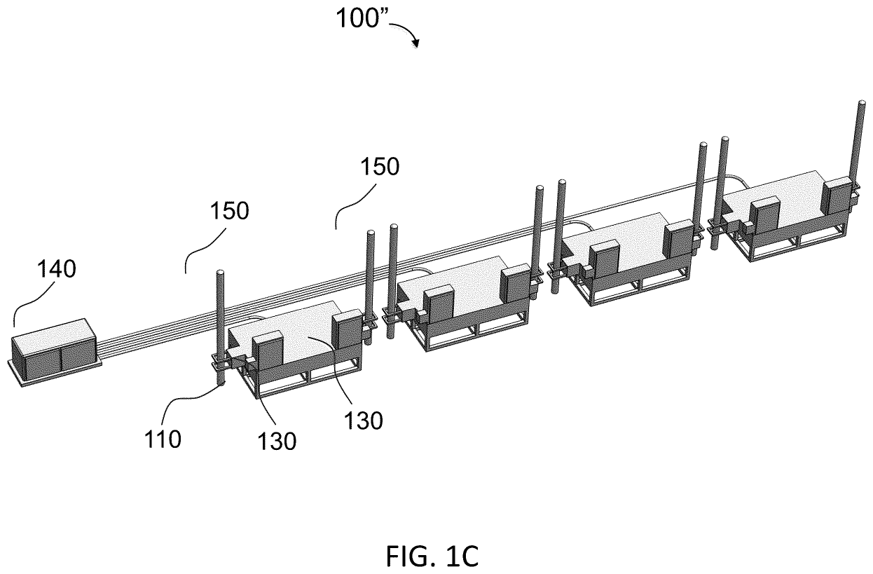

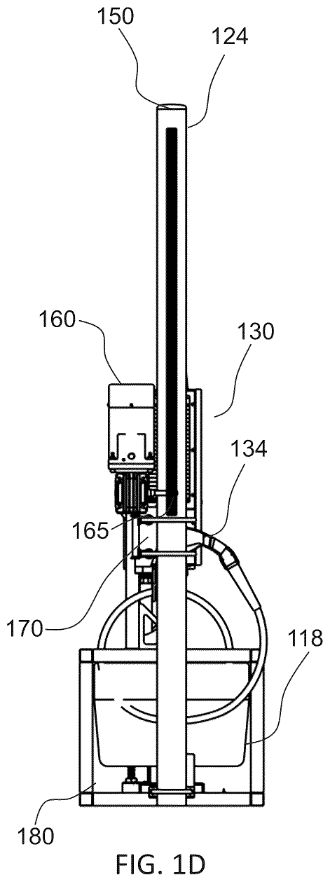

Referring now to FIG. 1A, shown is a schematic diagram of an apparatus in accordance with an embodiment. More specifically, as shown in FIG. 1A, apparatus 100 is an environmentally protected EV charging system 100. System 100 is implemented for location in an outdoor environment (or possibly a partially enclosed environment) that may be subject to the elements including water, which may come in contact with the system as a result of a flooding condition or other environmental condition such as damaging winds, hail, snow, fire, and so forth.

System 100 includes components that enable some amount of protection against these elements, particularly by way of enabling movement of components of system 100 to avoid water from a flooding condition.

As illustrated, system 100 includes a frame 110. Frame 110 may take various forms, but in general may be formed of a base 115 having a plurality of vertical members 120 extending therefrom. Frame 110 may be affixed to a ground surface to provide structural stability against environmental elements, both during normal operation and under an environmental trigger condition.

As shown, a plurality of EV chargers 130 may be adapted about at least some of vertical members 120. With this arrangement during buoyancy such as due to flood waters, EV chargers 130 are able to move vertically. Although not shown for ease of illustration in FIG. 1A, understand that each EV charger 130 may be adapted on a platform, which may support the corresponding EV charger and enable it to be raised when an environmental trigger condition occurs. To this end, during a flooding event, EV chargers 130 will float freely guided by the corresponding vertical members 120 and raise up on their corresponding platforms to be positioned away from, e.g., the flooding condition. To this end, each platform may be provided with a buoyant material to allow such operation.

In the view shown in FIG. 1A, each EV charger 130 is associated with a corresponding EV controller 135, which receives power via a corresponding conduit 136. Depending upon the implementation, EV controller 135 may further include or be coupled to an actuator to be controlled to raise and lower the corresponding EV charger 130 (in such cases, the buoyant members may not be present).

As shown, power is provided to EV controller 135 from a distribution power circuit 140 that is configured to receive incoming power, e.g., from a utility grid. In one or more embodiments, the actuator may be powered by an auxiliary power source (e.g., a battery storage system) to provide small auxiliary control power to hold EV charger 130 raised up (by electrical and mechanical control mechanisms) during the environmental condition. In an implementation having actuator-based movement, EV chargers 130 may be adapted around vertical members 120 on a platform having an additional electrical/mechanical track system to control vertical movement to a programmed and safe vertical location once the flooding event is detected. The same system will lower units once the environmental trigger condition is resolved.

Still referring to FIG. 1A, either included within distribution power circuit 140 or separate therefrom is a power disconnect circuit 145. In embodiments, power disconnect circuit 145 is configured to act as a circuit breaker to prevent power from being provided to the corresponding EV chargers when an environmental trigger condition is identified. In this way, damage to circuitry within EV chargers 130 can be avoided.

Although shown at this high level in the embodiment of FIG. 1A, understand that many variations and alternatives are possible. For example, while the implementation of FIG. 1A includes four EV chargers 130, more or fewer may be present in a given implementation. In addition, while there are more vertical members 120 than EV chargers 130, in other cases there may be a corresponding vertical member for each EV charger. Also while power circuits 140, 145 are located substantially at a center portion of frame 110, they may be located at peripheral ends or in another location in other implementations. Furthermore, while frame 110 is illustrated with base 115 having a grid-type arrangement, in other cases, base 115 may be implemented as a skid in which a solid base, e.g., formed of steel or other structural metal, can be used.

Referring now to FIG. 1B, shown is a block diagram of a system in accordance with another embodiment. As shown in FIG. 1B, system 100′ may be similarly a 4-EV charger environmental protection system. As such, common enumeration is used as in FIG. 1A. In this configuration, a frame 110 is formed such that one or more buoyant members 118 may be adapted within frame 110 to allow system 100 to float as needed.

In FIG. 1B, a ground surface 105 is illustrated. In this implementation, frame 110 may be adapted to a plurality of vertical members 150 (which as shown may be permanently affixed below ground surface 105). Via buoyant members 118, the entire arrangement may float. In other aspects, FIG. 1B may be arranged similarly to that described above with regard to FIG. 1A. However, note that in this implementation, EV chargers 130 are affixed to frame 110, rather than being adapted about vertical members, and the entirety of frame 100 may freely float about vertical members 150. Also in this implementation, during free floatation buoyancy, vertical members 150 guide displacement movement up and down. In other words, frame 110 may raise up and down freely according to the environmental trigger condition. In some cases mechanical components (e.g., rollers, guides or so forth) about vertical member 150 may couple to frame 110 to smooth the vertical movement (e.g., restrict movement side-to-side) avoid equipment stress.

Referring now to FIG. 1C, shown is a block diagram of a system in accordance with another embodiment. As shown in FIG. 1C, system 100″ may be a 8-EV charger environmental protection system. Again, common enumeration is used as in FIG. 1A. In this configuration, a plurality of frames 110 are provided, each of which is shown in this implementation to support 2 EV chargers 130. With this configuration, each frame 110 may independently float via buoyant members (not shown for ease of illustration in FIG. 1C, but included within frames 110).

As further shown, power delivery module 140 is located separately from frames 110 and may independently provide power to each EV charger 130.

As shown in FIG. 1D, this embodiment may have an upper frame 170 (supporting actuator, EV chargers, dispensers), and a lower frame base 180 (supporting floatation elements and sensors). The actuator includes a step motor 160 or other type of motor that provides motion through a high torque gear that connects to a helical gear 165 (e.g., a 3-inch diameter gear) or other type of gear to transmit mechanical power.

As shown, gear 165 meshes with a long gear track 124 that is fixed to pole 150, e.g., at least ¾ inch length starting from the top. By control, the system can be lifted up and down dynamically as intended. Other constructions may not include floating elements. Instead, upper frame 170 may be allowed to rest on a mechanical stop plate (not shown) with or without extension to a ground level.

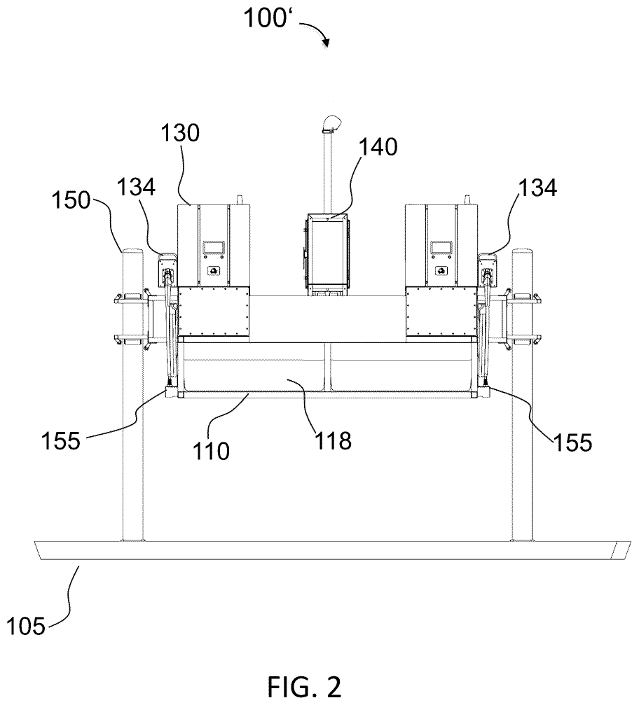

Referring now to FIG. 2, shown is a closeup view of a system in a raised position in accordance with an embodiment. As illustrated in FIG. 2, frame 110 is in an elevated position, along with its associated EV chargers 130. With the details shown in FIG. 2, EV chargers 130 may be positioned to be raised above an undesired environmental condition (e.g., flooding condition) via buoyant member 118, e.g., formed of a buoyant foam or plastic material, such that in the presence of a substantial flooding condition, EV chargers 130 may remain above a surface of the water. In embodiments, one or more sensors 155 (e.g., one or more of motion, position sensors, and/or liquid level sensors) may be adapted to frame 110, such that these sensors 155 issue a trigger if system 100′ begins floating, and thus causes a change in control of EV chargers 130. For example during a trigger event, sensor 155 operates as an electrical switch within control circuitry to disconnect input power from EV chargers 130. And in some instances, this trigger may also cause actuator circuitry (not shown in FIG. 2) to be activated, to raise frame 110.

Also illustrated in FIG. 2 are dispensers 134 of EV chargers 130 that provide an interface between EV charger 130 and a corresponding EV to be charged, as is well known.

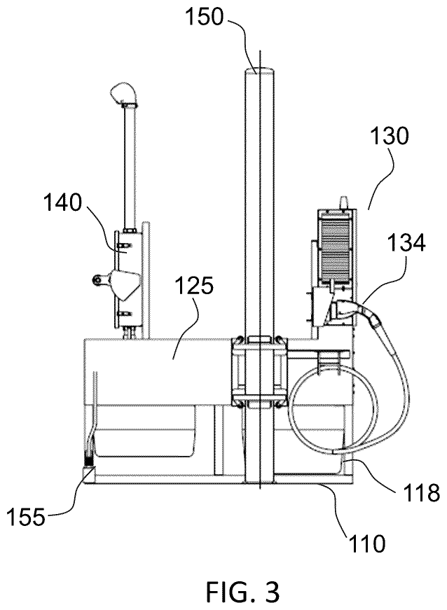

Referring now to FIG. 3, shown is a side view of an apparatus in accordance with an embodiment. As shown in FIG. 3, in this side view EV charger 130 is located in a lowered position. In this lowered position, EV charger 130 may be active to enable a user to charge an EV via dispenser 134. Note in this view that EV charger 130 sits on a platform 125. In some embodiments, platform 125, in turn, may further be coupled to an actuator (not shown in FIG. 3). In this way, when the actuator is activated, platform 125 raises, thus raising EV charger 130 from a lowered, active position to a raised, protection position. While in some cases, EV charger 130 may continue to be powered in a raised position, more typically when in a raised, protected position, EV charger 130 is not provided with power, to prevent shorting or other damage to components.

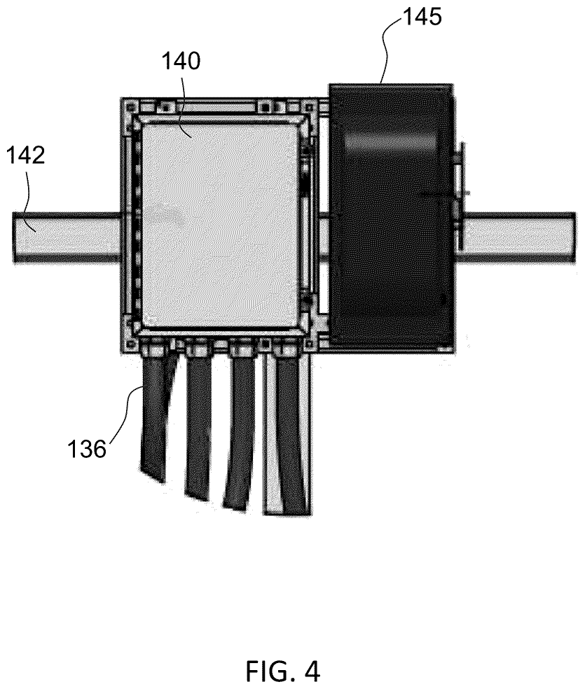

Referring now to FIG. 4, shown is an illustration of a close up of a power supply arrangement in accordance with an embodiment. Details include distribution power circuit 140 and power disconnect circuit 145. As shown, distribution power circuit 140 receives grid power via a conduit 142. In turn, distribution power circuit 140 distributes AC power to each of the plurality of EV chargers via corresponding conduits 136. In an embodiment, power disconnect system 145 provides power (in a parallel connection) to distribution power circuit 140.

In an embodiment, distribution power circuit 140 is configured to receive incoming three-phase power at a voltage of 480 volts AC (VAC). Distribution power circuit 140 may include a set of circuit breakers, e.g., 40 ampere (A) circuit breakers to individually prevent power distribution to a corresponding one of multiple EV chargers. Such individual disabling of an EV charger may be in response to an indication of a failure within the corresponding EV charger. Thus distribution power circuit 140 is configured, on receipt of a failure indication from a given EV charger, to disable power distribution to that EV charger by opening a given one of these circuit breakers.

In addition, distribution power circuit 140 also couples to power disconnect circuit 145. In response to an environmental trigger condition, power disconnect circuit 145 may be configured to prevent power distribution to all of the EV chargers. To this end, power disconnect circuit 145 may include a circuit breaker that operates at 200 A.

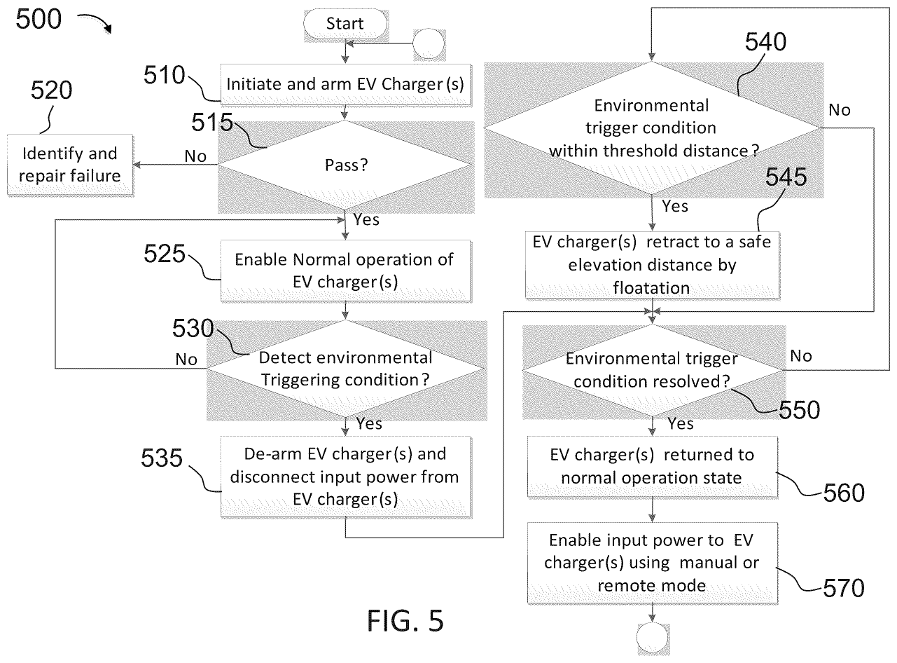

Referring now to FIG. 5, shown is a flow diagram of a method in accordance with an embodiment. As shown in FIG. 5, method 500 may be performed by a controller of an environmentally protected EV charging system, such as may be located in a parking lot or other outdoor location that may be subject to flooding or other environmental condition. In an embodiment, the controller may be implemented as one or more hardware circuits having one or more general-purpose processors configured to execute instructions that may be stored in a non-transitory storage medium, also present within the EV charging system. Such instructions may be implemented as firmware and/or software for execution by the controller.

In FIG. 5, method 500 begins by initializing and arming EV chargers of a system (block 510). Next at diamond 515 it is determined whether testing passes. If not, failures may be identified and reported at block 520. For example, a failure report may be sent to a remote location of a manager of the EV charging system. Repair operations may be performed to cure the failure. Instead when it is determined that the EV charger tests pass, control passes to block 525 where normal operation of the EV chargers is enabled. To this end, operating power may be provided from a distribution power circuit via corresponding conduits to each of the multiple EV chargers. Such normal operation may proceed, where each of the individual EV chargers can be individually controlled when an EV is coupled via a dispenser to the EV charging system. Such control may be performed locally within the EV charger, e.g., within an EV controller included in or coupled to the EV charger.

Still referring to FIG. 5, at diamond 530 it is determined whether an environmental trigger condition is detected. In an embodiment, one or more environmental sensors may detect such environmental trigger condition. Assume for purposes of discussion that the environmental trigger condition is a flooding condition that is detected by a liquid level sensor. If such trigger condition is detected, control passes to block 535 where the EV chargers are disabled and power is disconnected from the EV chargers. More specifically, the EV chargers are de-armed and input power is disconnected from the EV chargers. To effect such disconnection operation, a controller, e.g., present in the charging system may receive the environmental trigger condition and send a disable notification to the EV chargers so that they immediately stop charging any coupled EV's. In addition, the distribution power circuit also receives a notification from this controller and disconnects power from the EV chargers.

Still referring to FIG. 5, it may be determined at diamond 550 whether the environmental trigger condition has been resolved. If not, control passes to diamond 540, to determine whether the environmental trigger condition is within a threshold distance of the EV chargers (e.g., within 12 inches), which may be based on sensor measurement. If so, at block 545 the EV chargers are retracted to a safe elevation distance. In some embodiments, this may be achieved by floating the system via included buoyant members. In implementations having one or more actuators, the actuators may move the EV chargers away from the condition, possibly in connection with the buoyant members. As an example, these actuators that are adapted to the EV chargers cause them to be raised, e.g., along a vertical member, to be moved away from the flooding condition. Note that at this point there is no power provided to the EV chargers themselves. However, a minimal amount of power may still be provided to, e.g., the environmental sensors such that they may continue to detect the presence of the environmental condition.

Still referring to FIG. 5, it may again be determined at diamond 550 whether the environmental trigger condition has been resolved. If so, control passes to block 560 where the EV chargers may be returned to their normal operation state (e.g., original, nominal position). Control then passes to block 570 where input power is enabled to the EV chargers, using a manual or remote mode. In some cases when re-establishing power, initialization and testing operations may again be performed on the EV chargers. Understand while the embodiment of FIG. 5 shows an arrangement in which the control is local to the EV charging system, in other implementations at least some of the control operations can be initiated from a remote location that is in communication with the EV charging system such as by a wired or wireless communication. Although shown at this high level in the embodiment of FIG. 5, many variations and alternatives are possible.

In one aspect, the skid charging system is built by several modular EV DC charging converter units (e.g., 30-1000 KW, ≤1500 VDC and ≤1100 VAC). The skid system is equipped with controls and dedicated sensor systems to provide electrical, mechanical protection, as well as human safety. Additional potential system application variations are possible, such as providing an environmentally protected EV charging system that operates over a permanent body of water.

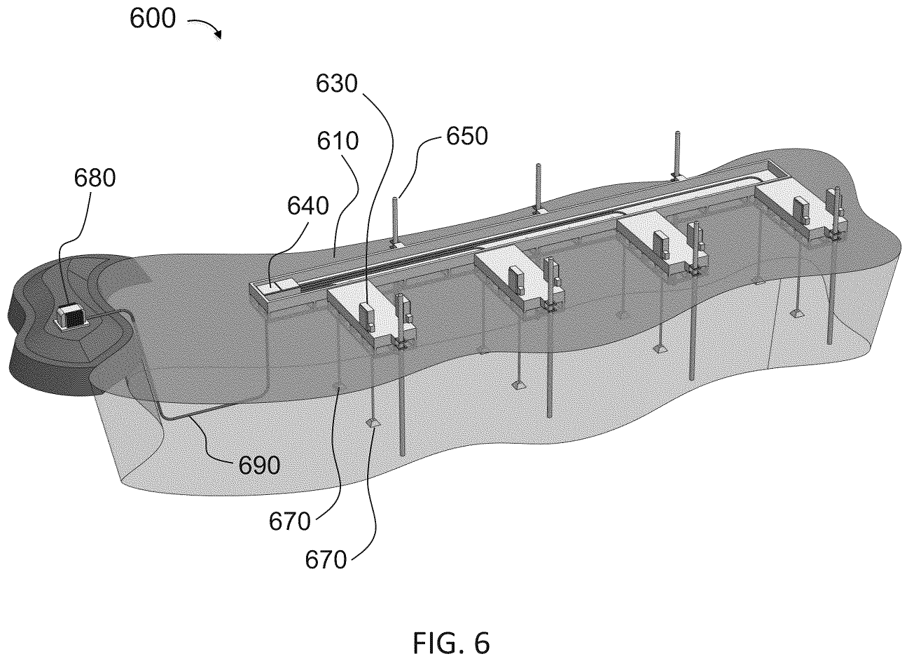

Referring now to FIG. 6, shown is a block diagram of an environmentally protected EV charging system in accordance with another embodiment. In the embodiment of FIG. 6, a system 600 is illustrated that may be used in a location adjacent to and including a permanent body of water. As illustrated, 8 (for example) EV chargers 630 are adapted to a floating dock 610. With this arrangement, a submarine cable 690 couples between on-shore switch gear equipment 680 that acts as a 3-phase power source and a distribution power circuit 640 that is adapted on a surface of dock 610.

With this arrangement, dock stabilization (floatation) is achieved at least in part by a cable-based anchoring system 670. In the implementation of FIG. 6, there may be 8 anchors 670, where each anchor can be adjusted by a manual system (not shown) or by an automatic system via an actuator (not shown). As further shown, a pile guide system 650 (which in the embodiment shown may include 7 piles) may support movement of dock 610. That is, during a weather event, pile guide system 650 allows dock 610 to move freely up (or down) during buoyancy. After the event has passed, cables are adjusted to stabilize the dock at normal operation. With this arrangement, 8 speed boats or other types of vessels (generically EVs) can be anchored to dock 610 for fast electric charging.

Referring now to Table 1, shown are specifications for an example environmentally protected EV charging system in accordance with an embodiment.

TABLE 1

| Parameter | Description |
|---|---|
| Skid Weight | 3752 Lbs. |
| Skid Height | 7 ft, 8 in |
| Skid Anchoring | solid ground |
| Floatation Criteria range | 0.5 to 3 inches for buoyancy to start |
| Intended Installation Locations | Commercial parking Lots |
| AC Input Power Source | 480 VAC, 3-phase, 60 Hz |
| EV DC Charger Unit Power | 30 kW, 1000 VDC |
| No. of Dispersers | 4 dispensers per skid |
| DC Converter Voltage Rating | 1000 VDC |
| Control Mechanism | Local and remote |
| Safety requirement | AC power-off via electrical/mechanical |
| | safety loop control |
| Electrical critical protection | Ground fault via residual current |
| | or other suitable sensing devices |

While the present disclosure has been described with respect to a limited number of implementations, those skilled in the art, having the benefit of this disclosure, will appreciate numerous modifications and variations therefrom. It is intended that the appended claims cover all such modifications and variations.

1. An apparatus comprising:
a frame to support a plurality of electric vehicle (EV) chargers;
the plurality of EV chargers, each of the plurality of EV chargers comprising a dispenser to provide charging power to at least one EV; and
at least one actuator coupled to at least a portion of the frame, wherein in response to a flooding condition in a vicinity of the apparatus, the at least one actuator is to raise the plurality of EV chargers to a raised position.

2. The apparatus of claim 1, further comprising at least one buoyant member adapted to at least a portion of the frame, wherein in the flooding condition in the vicinity of the apparatus, the at least one buoyant member is to cause the plurality of EV chargers to float above the flooding condition.

3. The apparatus of claim 2, wherein the at least one buoyant member comprises a plurality of floating members, wherein each of the plurality of EV chargers is adapted above at least one of the plurality of floating members, wherein each of the plurality of floating members comprises a buoyant foam or plastic enclosure.

4. The apparatus of claim 1, further comprising at least one environmental sensor, the at least one environmental sensor to identify the flooding condition.

5. The apparatus of claim 4, wherein the at least one environmental sensor comprises at least one sensor to sense that at least one of the plurality of EV chargers has changed position.

6. The apparatus of claim 1, further comprising a first circuit breaker coupled to the plurality of EV chargers, wherein the first circuit breaker is to prevent power from being provided to the plurality of EV chargers.

7. The apparatus of claim 6, further comprising a controller coupled to the first circuit breaker, wherein in response to an indication of the flooding condition, the controller is to cause the first circuit breaker to remove power to the plurality of EV chargers.

8. The apparatus of claim 7, wherein the controller, in response to the indication of the flooding condition, is to cause the at least one actuator to raise the plurality of EV chargers to the raised position.

9. The apparatus of claim 8, wherein the controller, in response to an indication that the flooding condition has resolved, is to cause the at least one actuator to return the plurality of EV chargers to a lowered position and enable the first circuit breaker to provide the power to the plurality of EV chargers.

10. The apparatus of claim 7, further comprising at least one second circuit breaker, wherein the controller is to cause the at least one second circuit breaker to remove power to a first EV charger of the plurality of EV chargers in response to an indication of a failure in the first EV charger.

11. The apparatus of claim 1, wherein the frame comprises a plurality of vertical members, wherein each of the plurality of EV chargers is adapted about a corresponding one of the plurality of vertical members to enable the corresponding EV charger to move vertically about the corresponding vertical member.

12. The apparatus of claim 11, wherein the frame comprises a plurality of platforms, each of the plurality of EV chargers adapted on one of the plurality of platforms.

13. The apparatus of claim 1, wherein the frame is to be affixed to a ground level on a mechanical extension or a pedestal to avoid an inundation condition.

14. A method comprising:
detecting, in a controller of an environmentally protected electric vehicle (EV) charging system comprising a plurality of EV chargers, an environmental triggering condition;
in response to detecting the environmental triggering condition, causing the plurality of EV chargers to be de-activated and disconnected from an input power source; and
moving the plurality of EV chargers to avoid the environmental triggering condition.

15. The method of claim 14, wherein moving the plurality of EV chargers to avoid the environmental triggering condition comprises floating the plurality of EV chargers above a nominal position.

16. The method of claim 14, further comprising:
receiving, in the controller, a sensor input to detect the environmental triggering condition; and
in response to the sensor input, sending a control signal to one or more actuators to cause the one or more actuators to raise the plurality of EV chargers above a nominal position to avoid the environmental triggering condition.

17. The method of claim 14, further comprising:
detecting, in the controller, a resolution of the environmental triggering condition; and
in response to detecting the resolution of environmental triggering condition, causing the input power source to be re-connected to the plurality of EV chargers.

18. The method of claim 17, further comprising causing the input power source to be re-connected to the plurality of EV chargers via a remote control operation.

19. A system comprising:
a dock to support a plurality of electric vehicle (EV) chargers, the dock to float on a water surface;
the plurality of EV chargers, each of the plurality of EV chargers comprising a dispenser to provide charging power to at least one EV;
an anchoring system to support the dock, the anchoring system comprising a plurality of anchors extending from a bottom of the dock to a floor below the water surface; and
a pile guide system having a plurality of pile guides, wherein during an environmental condition, the dock is to float upwardly or downwardly about the plurality of pile guides.

20. The system of claim 19, further comprising a distribution power circuit adapted on the dock, the distribution power circuit to provide power to the plurality of EV chargers.

21. The system of claim 20, further comprising a power source located adjacent the water surface on dry land, the power source to receive power from a utility grid and provide the power to the distribution power circuit.

22. The system of claim 21, further comprising a submarine cable to couple the power source to the distribution power circuit, at least a portion of the submarine cable submerged below the water surface.

23. An apparatus comprising:
a frame to support a plurality of electric vehicle (EV) chargers;
the plurality of EV chargers, each of the plurality of EV chargers comprising a dispenser to provide charging power to at least one EV; and
at least one buoyant member adapted to at least a portion of the frame, wherein in response to a flooding condition in the vicinity of the apparatus, the at least one buoyant member is to cause the plurality of EV chargers to float above the flooding condition.

24. The apparatus of claim 23, wherein the at least one buoyant member comprises a plurality of floating members, wherein each of the plurality of EV chargers is adapted above at least one of the plurality of floating members, wherein each of the plurality of floating members comprises a buoyant foam or plastic enclosure.

25. The apparatus of claim 23, further comprising:
a circuit breaker coupled to the plurality of EV chargers; and
a controller coupled to the circuit breaker, wherein in response to an indication of the flooding condition, the controller is to cause the circuit breaker to remove power to the plurality of EV chargers.
